(19) United States
(12) Patent Application Publication
(10) Pub. No.: US 2023/0079095 A1
(43) Pub. Date: Mar. 16, 2023

(54) System and Method for Controlling the Contact Pressure Between an Articulated Robotic Arm and a Secondary Object

(71) Applicant: Reliabotics LLC, New Brunswick, NJ (US)

(72) Inventor: Steven Evers, Newtown, PA (US)

(21) Appl. No.: 17/930,904

(22) Filed: Sep. 9, 2022

Related U.S. Application Data
(60) Provisional application No. 63/243,701, filed on Sep. 13, 2021.

(51) Int. Cl. B25J 9/16; B25J 11/00

(52) U.S. Cl. CPC B25J 9/1633; B25J 11/0065; B25J 9/1664; B25J 9/1679; B25J 9/162

(57) ABSTRACT

A system for moving an object against a working surface of a finishing machine. A mounting platform is provided that is supported by a stationary frame. The mounting platform can only move reciprocally relative to the stationary frame along a linear line of motion. An articulating arm is mounted on the mounting platform and moves with the mounting platform. A linear actuator is provided having a first end coupled to the mounting platform and an opposite end mounted to the stationary frame. The linear actuator has a midline that is parallel to, and aligned with, the linear line of motion. A finishing machine is provided that has a working surface. The articulating arm touches objects to the working surface at a point of contact that is coplanar with the linear line of motion. This directs forces along the linear line of motion and into the linear actuator.

### RELATED APPLICATIONS

This application claims the benefit of U.S. provisional application No. 63/243,701 dated Sep, 13, 2021.

### BACKGROUND OF THE INVENTION

### 1. Field Of The Invention

In general, the present invention relates to control systems that manage the operation of a robotic arm. More particularly, the present invention relates to control systems that control the contact pressure between the working end of a robotic arm and a secondary object being touched by the robotic arm.

### 2. Prior Art Description

Robots and other automated machinery are often used in industry to manufacture and assembly various components. However, no matter how precise a machine is, there is always some variation between parts. Often that variation comes in the form of burrs, flashing and/or other defects that are inherent in the manufacturing process being used.

Many manufacturers, therefore, subject parts to secondary finishing processes that are designed to remove burrs, flashing and/or other such defects. Depending upon the shape of the part, the secondary finishing processes require a part to be pressed against a grinding wheel, sanding belt, polishing wheel, or similar finishing tool. If the part is pressed against the finishing tool with too much force, damage can occur to the manufactured part, the finishing tool, or both. If too little force is used, not all the defects on the manufactured part are fully removed. Consequently, the process of finishing a product is a complex balance between movement and pressure. The proper balance is very difficult to program since position and severity of defects vary between parts. As a consequence, many manufacturers rely upon skilled workers to finish manufactured parts by hand. A worker holding a part has the ability to see the part and control the pressure between the part and the working surface of a finishing machine. The control is balanced to correct the defect without damaging either the part or the finishing machine.

Many manufacturers would like to have fully automated facilities that do not require workers to manually finish parts. Attempts to automate the finishing of parts often results in many defective parts. Accordingly, the use of skilled workers, rather than automated machinery, becomes the more economical choice.

In U.S. Pat. No. 11,312,015 to Evers, a complex robotic system is disclosed where a robotic arm moves objects against finishing machinery using a pressure-verses-time control software. That is, the robot ensures that different pressures are applied to the object being finished at different times. The problem associated with such prior art systems is that the forces that act upon the part being finished are multi-dimensional. The robot arm can cause an object to contact a finishing machine at a wide variety of positions and orientations. Accordingly, upon contact, forces in many different directions are created simultaneously. Although the forces being applied to the part in one direction are within accepted tolerances, the forces in other directions, or in combination, can cause damage to the object being finished and/or to the finishing machine. Furthermore, robot systems with such complexities of movement greatly increases the cost of the robotic system and the difficulties of programming the robotic system. Accordingly, the robotic system is less competitive when compared to the use of skilled labor.

The present invention is an improvement to the system found in U.S. Pat. No. 11,312,015, wherein the present invention requires less sophisticated components that simplify motion and can be manufactured at much lower costs. This reduces both the cost of the system and the complexity of its programming, therein making the system more commercially viable. The details of the present invention are described and claimed below.

### SUMMARY OF THE INVENTION

The present invention is a system and method for moving an object against a working surface of a finishing machine. The system uses a linear slide table set within a stationary frame. The linear slide table has a mounting platform that can only move reciprocally relative to the stationary frame along a linear line of motion.

An industrial robot with an articulating arm is mounted on the mounting platform. The articulating arm moves with said mounting platform along said linear line of motion as forces are applied to the linear slide table. A linear actuator is provided between the stationary frame and the linear slide table. The linear actuator has a first end coupled to the mounting platform and an opposite second end that is mounted to the stationary frame. The linear actuator has a midline between the first end and the second end that is parallel to, and aligned with, the linear line of motion achievable through the linear slide table.

A finishing machine is provided that has a working surface. The articulating arm is capable of grasping an object and touching the object to the working surface at a point of contact. The point of contact is coplanar with the linear line of motion of the linear slide table and the midline of the linear actuator. In this manner, forces applied to the object at the point of contact act along the linear line of motion.

In this manner, by controlling forces along the linear line of motion with the linear actuator, the force between the object and the working surface of the finishing machine can be dynamically controlled with great precision and at a low cost.

### BRIEF DESCRIPTION OF THE DRAWINGS

For a better understanding of the present invention, reference is made to the following description of exemplary embodiments thereof, considered in conjunction with the accompanying drawings, in which:

FIG. 1 shows an exemplary embodiment of the present invention system in a retracted position;

FIG. 2 shows the exemplary embodiment of the present invention system in an extended position;

FIG. 3 is a top view of the exemplary embodiment of FIG. 2 to illustrate the liner line of motion; and

FIG. 4 shows an alternate embodiment of the present invention system.

### DETAILED DESCRIPTION OF THE DRAWINGS

The present invention system and method can be configured in many ways and can be adapted for use in many applications. However, the present invention system is especially well suited for applications where a robotic arm is being used to deburr a manufactured part by bringing the part into contact with a finishing machine, such as a grinding wheel or a sanding belt. Accordingly, the exemplary embodiments selected for the purposes of description and illustration show the present invention system containing a robotic arm and two auxiliary finishing machines. The illustrated embodiments, however, are merely exemplary and should not be considered limitations when interpreting the scope of the appended claims.

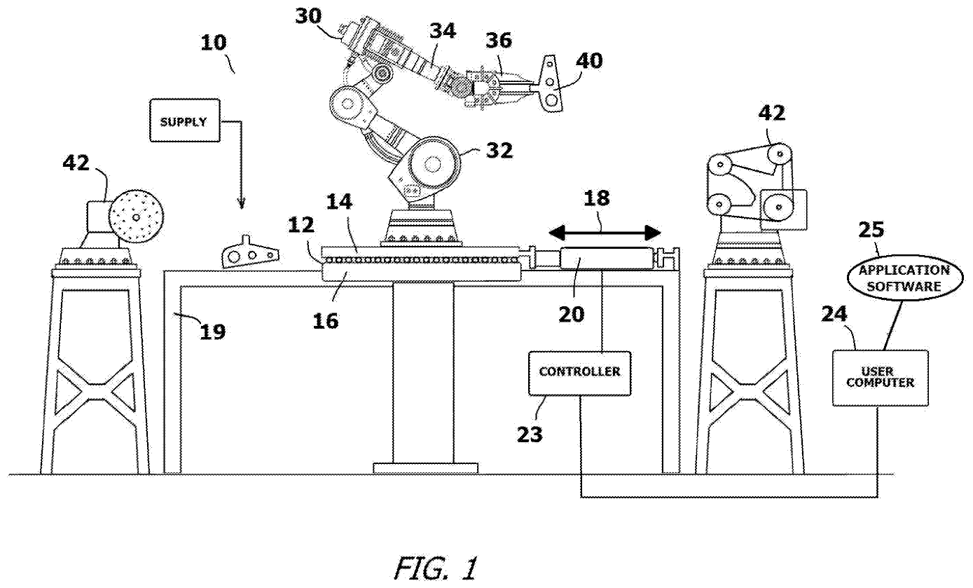

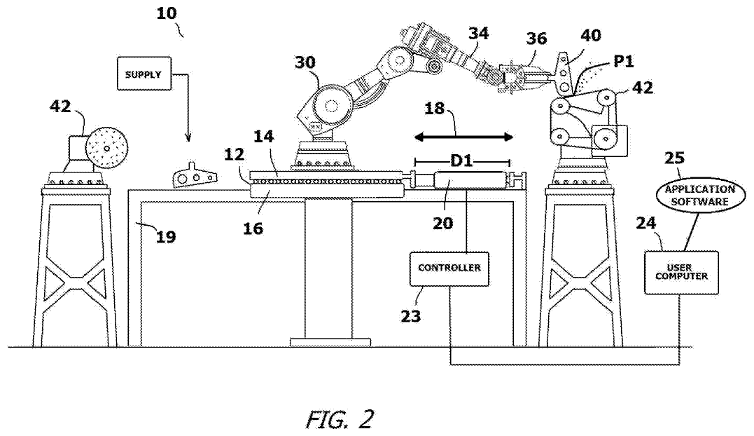

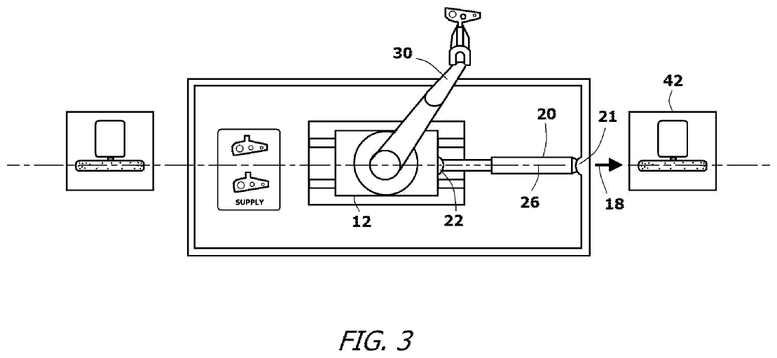

Referring to FIG. 1 in conjunction with FIG. 2 and FIG. 3, a first exemplary version of the present invention part finishing system 10 is shown. The part finishing system 10 utilizes a linear slide table 12. The linear slide table 12 has a mounting platform 14 set atop a base 16. The mounting platform 14 is joined to the base 16 using ball bearings, rails and/or slides that enable the mounting platform 14 to move relative the base 16 along a single linear line of motion 18. The movement of the mounting platform 14 relative the base 16 is restricted to reciprocal movement along the linear line of motion 18 with a high degree of precision and nearly no friction. There are numerous linear slide tables that are commercially available and can be adapted for use as part of the present invention part finishing system 10.

The base 16 of the linear slide table 12 is affixed to a framework 19. The framework 19 is fixed in place within the room in which the part finishing system 10 is located. The framework 19 is typically bolted to a floor. The framework 19 is mounted in place to prevent any incidental movement of the framework 19 caused by movement of the mounting platform 14 and/or the equipment the mounting platform 14 supports.

A linear actuator 20 is provided. The linear actuator 20 has a first end 21, an opposite second end 22 and a midline 26 that extends between the first end 21 and the second end 22. The linear actuator 20 selectively elongates and contracts along its midline 26. The distance D1 along the midline 26 between the first end 21 and the second end 22 can be controlled with great precision using computerized controls.

The linear actuator 20 is positioned so that the midline 26 of the linear actuator 20 is parallel to, an aligned with, the linear line of motion 18 of the mounting platform 14. That is, the midline 26 of the linear actuator 20 and the linear line of motion 18 are coplanar in the same vertical plane. The first end 21 of the linear actuator 20 is attached to the mounting platform 14. The second end 22 of the linear actuator 20 is attached to the framework 19 at a point along the linear line of motion 18. Accordingly, when the linear actuator 20 is in operation, the mounting platform 14 is moved along its linear line of motion 18 with great precision while the framework 19 remains stationary.

The operation of the linear actuator 20 is directed by a system controller 23. The system controller 23 monitors tensile and compressive forces experienced by the linear actuator 20 in real time along the linear line of motion 18 and precisely controls the linear actuator 20 to maintain preprogrammed forces between the mounting platform 14 and the framework 19. The system controller 23 is operated by a user computer 24. The user computer 24 can be any computing device programmed with the application software 25 needed to operate the system controller 23. Accordingly, the computer 24 can be a tabletop computer, a laptop computer or even a smart phone.

The application software 25 run by the system controller 23 enables the linear actuator 20 to create and resist forces that act directly along the linear line of motion 18. For a purpose that is later explained, the application software 25 sets a threshold for the forces that can act along the linear line of motion 18. For example, a threshold force of 10 PSI can be set for a particular moment in time. At that time, the linear actuator 20 will maintain a 10 PSI force between the mounting platform 14 and the framework 19. Should a force be experienced along the linear line of motion 18 that surpasses the threshold force, then the linear actuator 20 will yield and contract along the linear line of motion 18. The mounting platform 14 will then move relative to the framework 19 until the preprogrammed threshold force is again achieved. Likewise, should a force be experienced along the linear line of motion 18 that is less than the programmed threshold force, then the linear actuator 20 will elongate along the linear line of motion 18. The mounting platform 14 will then move relative to the framework 19 until the programmed threshold force is achieved. It will therefore be understood that the linear actuator 20 only acts along the linear line of motion 18 and that the linear actuator 20 responds to pressure-verses-time programming. That is, the linear actuator 20 is programmed to provide different pressures at different times along the linear line of motion 18.

An industrial robot 30 is set atop the mounting platform 14. The industrial robot 30 has an arm base 32 that is affixed to the mounting platform 14. The arm base 32 is centered along the linear line of motion 18. An articulating arm 34 extends from the arm base 32. The articulating arm 34 terminates with a tool head 36. In the shown embodiment, the tool head 36 is a gripper specifically designed to lift a particularly shaped object 40 for finishing. The industrial robot 30 is controlled by the programmable system controller 23 that can be preprogrammed with complex movement patterns for the articulating arm 34. The programming sent to the industrial robot 30 is position-versus-time programing that instructs the movements of the articulating arm 34 and the tool head 36 as a function of time. During operations, the industrial robot 30 attempts to complete its programmed movement pattern regardless of forces encountered by the articulating arm 34 and the tool head 36. Many types of industrial robots 30 can be utilized by the present invention part finishing system 10. The industrial robot 30 can be custom-made or can be a commercial robot, such as one of the industrial robots commercially sold by the Kuka Company of Augsburg, Germany.

Finishing machines 42 are provided. One or more finishing machines 42 are set within the reach of the industrial robot 30. The finishing machines 42 are either mounted to the fixed framework 19 or are mounted to the ground. In this manner, the positions of the finishing machines 42 are fixed and do not vary with time. The finishing machines 42 can be any machine capable of finishing some element of the object 40 being manipulated by the industrial robot 30. For example, the finishing machines 42 can be grinding machines and/or belt sanders for removing burrs from the object 40. Alternatively, the finishing machines 42 can be polishing wheels to buff the object 40. Each of the finishing machines 42 has a working surface 44 where the object 40 being finished contacts the finishing machine 42 and is affected by the finishing machine 42. The finishing machines 42 are positioned so that the working surface 44 has a point of contact P1 with the finishing machine 42 that is coplanar with the linear line of motion 18 and the midline 26 of the linear actuator 20. In this manner, most forces applied to the object 40 by the finishing machine 42 are transferred to the industrial robot 30 along the linear line of motion 18.

The industrial robot 30 is programmed to lift the object 40 in need of finishing and manipulate the object 40 in accordance with its position-versus-time programming. In most prior art applications, the arm base of an industrial robot is set in a fixed location. In the present part finishing system 10, the industrial robot 30 has an arm base 32 that is affixed to the mounting platform 14. The articulating arm 34 of the industrial robot 30 moves with position-versus-time programming. The linear actuator 20 moves the mounting platform 14 with pressure-versus-time programming. The system controller 23 time synchronizes the pressure-versus-time programing with the position-versus-time programming. For example, during the operating cycle of the industrial robot 30 the articulating arm 34 and the tool head 36 are moved with position-versus-time programming. During a particular moment, the optimal contact forces between the object 40 and one of the finishing machines 42 may be ten PSI. Accordingly, at this exact moment in time, the pressure-versus-time programming of the linear actuator 20 would be set to a counteracting force of ten PSI. If contact forces along the linear line of motion 18 at that moment in time exceed ten PSI, then the linear actuator 20 will yield in order to diminish the force. When the linear actuator 20 moves, it moves the mounting platform 14. The movement of the mounting platform 14, in turn, moves the industrial robot 30, therein causing the object 40 being held against one of the finishing machines 42 to engage the finishing machine 42 with less force, without moving the articulating arm 34. Likewise, if the force is less than the programmed 10 PSI along the linear line of motion 18, then the linear actuator 20 elongates in order to increase the force to reach the preprogrammed threshold. In this manner, the contact forces applied to the object 40 by the finishing machines 42 along the linear line of motion 18 can be dynamically maintained.

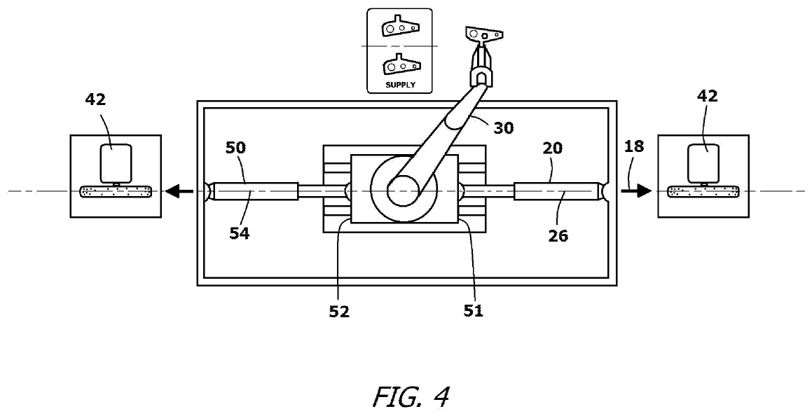

Referring to FIG. 4, a variation of the part finishing system is provided. This system shares the same components as the embodiment of FIGS. 1, 2 and 3. Accordingly, the same reference numbers are used to identify the same parts.

In the embodiment of FIG. 4, an industrial robot 30 is set upon a liner slide table 12 that enables the entire industrial robot 30 to reciprocally move along a very specific linear line of motion 18. A first linear actuator 20 is provided that acts in the same linear line of motion 18. The first linear actuator 20 extends from a first side 51 of the linear slide table 12. What is new is the use of a second linear actuator 50 on the opposite second side 52 of the linear slide table 12. The second linear actuator 50 has a midline 54 that is linearly aligned with the midline 26 of the first linear actuator 20.

Finishing machines 42 are set on opposite sides of the linear slide table 12. The finishing machines 42 have points of contact P1, P2 that are coplanar with the midline and can be connected to the can move the in the same plane as the linear line of motion 18, the midline 26 of the first linear actuator 20, and the midline 54 the second linear actuator 50. The use of two linear actuators 20, 50 doubles the forces that can be provided and/or resisted along the linear line of motion 18. The use of two linear actuators 20, 50 also lets smaller actuators be used in place of a single larger actuator. This can reduce costs, power requirements and energy consumption.

Referring to FIG. 1, FIG. 3, and FIG. 4, it will be understood that regardless of having one linear actuator 20 or more than one, the industrial robot 30 initially picks up the object 40 from a supply position. The industrial robot 30 then moves various surfaces of the object 40 into contact with the finishing machines 42 while maintaining a point of contact with working surfaces 44 that are in line with the linear line of motion 18. This is a simple position-versus-time program pattern. The position-versus-time program pattern is supplemented by the pressure-versus-time program pattern of the linear actuators in use. Should the pressure between the object 40 and one of the finishing machines 42 be under or over the programmed pressure, the linear actuators 20 and/or 50 will either elongate or contract to bring the contact pressure back within the programmed specifications. By controlling the contact pressure between the object 40 and the finishing machines 42 as a function of position, time, and pressure, the part finishing system 10 can better simulate the movements of a skilled worker's hands.

It will be understood that the embodiments of the present invention that are illustrated and described are merely exemplary and that a person skilled in the art can make many variations to those embodiments. All such embodiments are intended to be included within the scope of the present invention as defined by the claims.

What is claimed is:

1. A system for moving an object against a working surface of a finishing machine, said system comprising:
a stationary frame;
a mounting platform supported by said frame that can only move reciprocally relative to said stationary frame along a linear line of motion;
an articulating arm mounted on said mounting platform, wherein said articulating arm moves with said mounting platform along said linear line of motion;
a first linear actuator having a first end coupled to said mounting platform and an opposite second end mounted to said framework, wherein said first linear actuator has a midline between said first end and said second end that is parallel to, and aligned with, said linear line of motion; and
a first finishing machine having a working surface, wherein said articulating arm is capable of grasping said object and touching said object to said working surface at a point of contact that is coplanar with said linear line of motion.

2. The system according to claim 1, wherein said articulating arm grasps said object and moves said object into contact with said working surface following a programmed movement pattern and a programmed contact pressure pattern.

3. The system according to claim 2, wherein said first linear actuator automatically elongates along said midline between said first end and said second end should pressure forces experienced along said linear line of motion fall below said programmed contact pressure pattern during any period of time.

4. The system according to claim 2, wherein said first linear actuator automatically contracts along said midline between said first end and said second end should pressure forces experienced along said linear line of motion surpasses said programmed contact pressure pattern during any period of time.

5. The system according to claim 1, wherein said articulating arm is part of an industrial robot mounted atop said mounting platform.

6. The system according to claim 1, further including a second linear actuator that is disposed between said mounting platform and said framework, wherein said second linear actuator has a second midline that is parallel to, and aligned with, said linear line of motion.

7. The system according to claim 6, wherein said mounting platform is interposed between said first linear actuator and said second linear actuator, and both said first linear actuator and said second linear actuator are linearly aligned along said linear line of motion.

8. A method of working an object by moving said object against a working surface, said system comprising:
providing a machine having said working surface that can be contacted by said object at a point of contact;
providing an articulating arm that is capable of engaging said object and moving said object against said working surface at said point of contact;
mounting said articulating arm on a linear slide table that can only travel along a linear motion line;
attaching at least one linear actuator to said linear slide table, wherein said at least one linear actuator elongates and contracts along a midline, and where said midline is parallel to, and aligned with, said linear motion line, and wherein said point of contact on said working surface of said machine is coplanar with said midline and said linear motion line;
controlling said articulating arm and said at least one linear actuator to cause said object to contact said working surface of said machine following a movement pattern and a contact pressure pattern.

9. The method according to claim 8, wherein said at least one linear actuator automatically changes length along said midline should pressure forces experienced along said linear motion line deviate from said contact pressure pattern.

10. The method according to claim 8, wherein said articulating arm is part of an industrial robot mounted atop said linear slide table.

11. The system according to claim 8, wherein said linear slide table is interposed between a first linear actuator and a second linear actuator, and both said first linear actuator and said second linear actuator have midlines that are parallel to, and linearly aligned with, said linear motion line.

12. The method according to claim 8, further including providing a common computer controller for selectively controlling both said articulating arm and said at least one linear actuator.
